(19) United States
(12) Patent Application Publication
(10) Pub. No.: US 2026/0304352 A1
(43) Pub. Date: Oct. 1, 2026

(54) A RANGING APPLICATION SERVICE IN A WIRELESS COMMUNICATION NETWORK

(71) Applicant: Lenovo (Singapore) Pte. Limited, Singapore (SG)

(72) Inventors: Emmanouil Pateromichelakis, Viersen (DE); Dimitrios Karampatsis, Ruislip (GB)

(73) Assignee: Lenovo (Singapore) Pte. Limited, Singapore (SG)

(21) Appl. No.: 19/136,986

(22) PCT Filed: Jan. 27, 2023
(86) PCT No.: PCT/EP2023/052075

§ 371 Date: Jun. 9, 2025

(30) Foreign Application Priority Data
Dec. 12, 2022 (GR) 20220101025

(51) Int. Cl. H04W 64/00; H04W 8/22; H04W 92/18

(52) U.S. Cl. CPC H04W 64/00; H04W 8/22; H04W 92/18

(57) ABSTRACT

There is further provided a method of a ranging application service by a location management entity, the method comprising: obtaining information associated with location of a plurality of user equipments; evaluating in respect of a pair of user equipments from the plurality of user equipments based on the obtained information associated with location of the pair of user equipments, whether there exists a requirement for utilizing a further user equipment to assist in the ranging application service; and if the further user equipment is required to be utilized, selecting the further user equipment based on information associated with location of the further user equipment; and sending at least one side-link positioning configuration information to the pair of user equipments and the further user equipment.

### FIELD

The subject matter disclosed herein relates generally to the field of implementing a ranging application service in a wireless communication network. This document defines a location management entity, a method in a location management entity, a user equipment operating as either a reference user equipment or a further user equipment, and a method in a user equipment operating as a reference user equipment or a further user equipment in a ranging application service area.

### INTRODUCTION

Location Services (LCS) are part of the 3GPP Architecture and RAN framework and enable the identification and standardised reporting of location information. The location information may relate to one UE or a group of UEs. This location information can be exposed to the user, a mobile equipment, a network operator, a service provider, any value added service providers and used for PLMN internal operations.

A ranging application service may comprise a ranging-based service implemented as an application utilizing the distance between two UEs and/or the direction of one UE from the other one. In a 3D case, direction includes horizontal direction and elevation direction. Ranging-based services can apply to a variety of vertical services, such as consumer, smart home, smart city, smart transportation, smart retail, and industry 4.0. Some ranging-based services may only require the distance measurement, some may only require direction measurement, others can require both distance and direction measurements.

### SUMMARY

A problem with ranging application services in wireless networks is that of how to support the discovery of, and configure and provision policies/parameters related to, entities to perform side-link positioning/ranging services, to ensure that the UEs (acting as reference, assistant, and target UEs) meet ranging performance requirements.

Disclosed herein are procedures for a ranging application service in a wireless communication network. Said procedures may be implemented by a location management entity, a method in a location management entity, a user equipment operating as either a reference user equipment or a further user equipment, and a method in a user equipment operating as a reference user equipment or a further user equipment in a ranging application service area.

Accordingly, there is provided a location management entity for a ranging application service, the location management entity comprising a processor; and a memory coupled with the processor. The processor is configured to cause the location management entity to: obtain information associated with location of a plurality of user equipments; evaluate in respect of a pair of user equipments from the plurality of user equipments based on the obtained information associated with location of the pair of user equipments, whether there exists a requirement for utilizing a further user equipment to assist in the ranging application service. If the further user equipment is required to be utilized, then the processor is further arranged to select the further user equipment based on information associated with location of the further user equipment; and send at least one side-link positioning configuration information to the pair of user equipments and the further user equipment.

There is further provided a method of a ranging application service by a location management entity, the method comprising: obtaining information associated with location of a plurality of user equipments; evaluating in respect of a pair of user equipments from the plurality of user equipments based on the obtained information associated with location of the pair of user equipments, whether there exists a requirement for utilizing a further user equipment to assist in the ranging application service; and if the further user equipment is required to be utilized, selecting the further user equipment based on information associated with location of the further user equipment; and sending at least one side-link positioning configuration information to the pair of user equipments and the further user equipment.

There is further provided a user equipment operating as a reference user equipment or a further user equipment in a ranging application service area, the user equipment comprising: a processor; and a memory coupled with the processor, the processor configured to cause the user equipment to: receive at least one side-link positioning configuration information from a location management entity.

There is further provided a method of a reference user equipment or a further user equipment in a ranging application service area, the method comprising receiving at least one side-link positioning configuration information from a location management entity.

Such a location management entity and/or user equipment tends to facilitate efficient support of the sidelink positioning/ranging service operation and continuity, and in particular how to select, configure and provision assistant user equipments to act as relays for supporting ranging service in non-Line of Sight (nLoS) conditions.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for a ranging application service in a wireless communication network will now be described, by way of example only, with reference to the accompanying drawings, in which:

FIG. 1 is a schematic illustration of a wireless communication system;

FIG. 2 is a schematic illustration of a user equipment apparatus;

FIG. 3 is a schematic illustration of a network node;

FIG. 4 is a schematic illustration of a high-level system architecture;

FIG. 5 is a schematic illustration of a side-link positioning enablement service architecture;

FIG. 6 is a schematic illustration of an on-network functional model;

FIG. 7 is a schematic illustration of an off-network functional model;

FIG. 8 is a schematic illustration of a side-link positioning enablement service architecture;

FIG. 9 is a messaging diagram depicting steps for carrying out subscription and configuration for SL positioning management;

FIG. 10 is a messaging diagram depicting steps for carrying out a side-link positioning operation phase in both in-coverage and out-of-coverage scenarios;

FIG. 11 illustrates a method of performing a ranging application service by a location management entity; and

FIG. 12 illustrates a method 1200 of a reference user equipment or a further user equipment in a ranging application service area.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

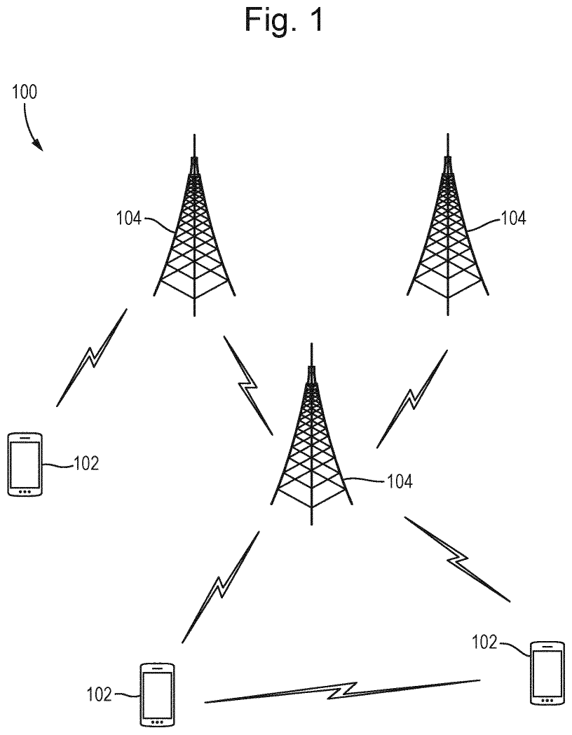

FIG. 1 depicts an embodiment of a wireless communication system 100 for a ranging application service in a wireless communication network. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), an application function, a service enabler architecture layer (“SEAL”) function, a vertical application enabler server, an edge enabler server, an edge configuration server, a mobile edge computing platform function, a mobile edge computing application, an application data analytics enabler server, a SEAL data delivery server, a middleware entity, a network slice capability management server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

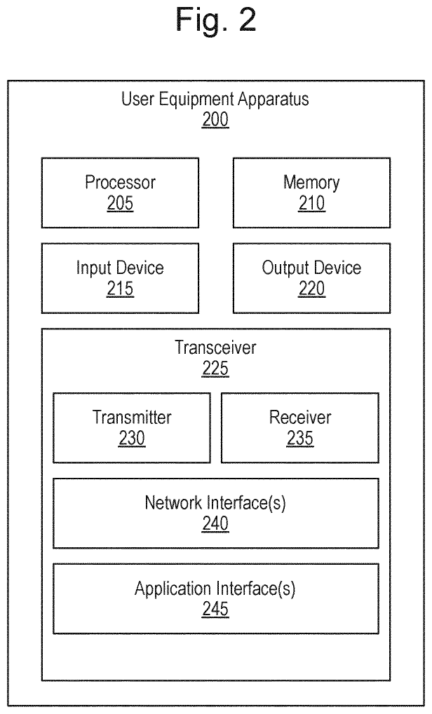

FIG. 2 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described herein. In particular, the UE apparatus 200 may comprise a remote unit 102, a client UE 405, 802, a target UE 410, 810, 902, an assistant UE 420, 814, 904, a UE 536, 538, 540, 610, 704, 708, a reference UE 812, 908. Each UE, target UE, client UE assistant UE and reference UE described herein in relation to one figure may be used in relation to that of another figure.

The user equipment apparatus 200 includes a processor 205, a memory 210, an input device 215, an output device 220, and a transceiver 225. The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communication network. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

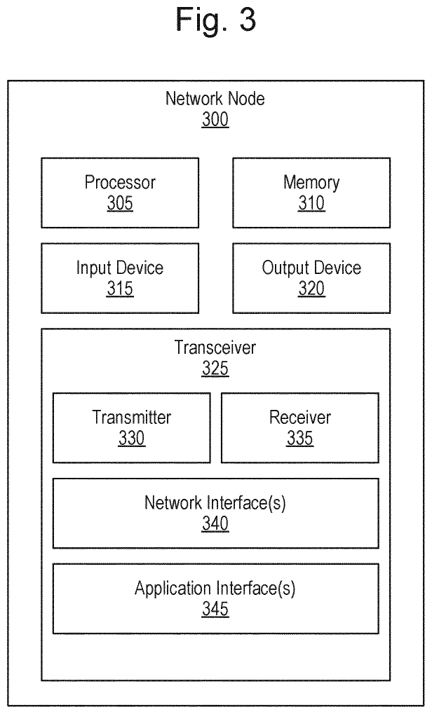

FIG. 3 depicts further details of the network node 300 that may be used for implementing the methods described herein. The network node 300 may be one implementation of an entity in the wireless communication network, e.g. in one or more of the wireless communication networks described herein. In particular, the network node 300 may comprise a network unit 104, an LMF/AMF 425, ranging enabler service 806 SL positioning server 804, a seal LMS 910 or a VAL server 912. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

LCS are inherently part of the 3GPP Architecture and RAN framework to enable the identification and standardized reporting of location information of a UE or group of UEs. This location information can be exposed to the user, mobile equipment, network operator, service provider, value-added service providers and for PLMN internal operations.

Ranging-based services are applications utilizing the distance between two UEs and/or the direction of one UE from the other. In the 3-dimensional case, direction includes horizontal direction and elevation direction. Ranging-based services can apply to a variety of verticals, such as consumer, smart home, smart city, smart transportation, smart retail, and industry 4.0. Some ranging-based services only require distance measurements, while others only require direction measurements. Still others may require both distance and direction measurements.

In TS 22.261 v 15.7.0, some requirements have been defined which are related to exposure:
The 5G system shall be able to start ranging and stop ranging according to the application layer's demand.
The 5G system shall be able to provide mechanisms for a Mobile Network Operator (MNO), or authorized third-party, to provision and manage ranging operation and configurations.
The 5G system shall be able to support mechanisms for a UE to assist another UE to perform ranging of a third UE if the requesting UE is in Line of Sight (LoS) with the assisting UE and the assisting UE is in LoS with the third UE. It cannot be assumed that all ranging UEs support the same application for exchange of information.
The 5G system shall be able to support the ability of ranging enabled UEs to determine the ranging capabilities (e.g., capabilities to perform distance and/or angle measurement) of other ranging enabled UEs.
The 5G system shall be able to allow a ranging enabled UE to determine if another ranging enabled UE is stationary or mobile, before and/or during ranging.
The 5G system shall allow ranging between a pair of UEs triggered by and exposed to a third UE.
The 5G system shall allow ranging service between a pair of UEs triggered by and exposed to the application server.

Based on the above requirements, the following considerations can be made:
The application layer can request 5GS to start or stop ranging based on its requirement.
An authorized third-party (which may be the enabler) can provision and manage ranging configurations.
Ranging UEs that exchange information may belong to the same or different application.
A first UE can determine the mobility pattern of a second UE.
A third UE or an application server can trigger ranging between the first and second UEs.
A third UE or an application server can obtain ranging information related to ranging service between the first and second UEs.

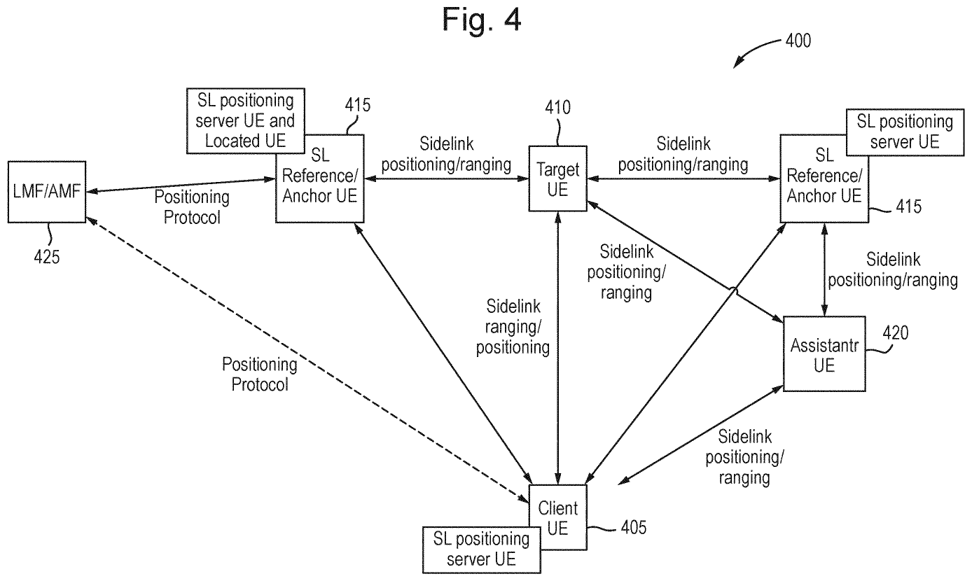

FIG. 4 depicts a high-level architecture 400 suitable for implementing a ranging/side-link (SL) positioning use case.

The architecture 400 comprises a client UE 405, a target UE 410, SL reference UEs 415, an assistant UE 420, and a Location Management Function (LMF)/Access and Mobility Management Function (AMF) 425.

The client UE 405 can send a request to obtain its range from the target UE 410, or a request to obtain location of the target UE 410, to the SL reference UEs 415.

The target UE 410 can send a request to obtain its own location (via SL positioning/ranging) to the SL reference UEs 415.

From a network perspective, 3GPP focuses on aspects related to the authorization, provisioning, and discovery of UEs that support or assist in ranging services. Some aspects can be covered by existing mechanisms specified in Proximity Based Services (ProSe), as defined in TS 23.304 v 17.4.0.

From an enablement layer perspective, the issues which remain unsolved are the following:
How to enable a third-party customer to provision ranging service parameters and configurations to the involved UEs.
How to support the selection and configuration of UEs acting as assistant UEs.
How to monitor whether the ranging service requires the use of assistant UE.

Hence, a problem to be solved by the present invention is that of how to efficiently support the SL positioning/ranging service operation and continuity, and in particular that of how to select, configure and provision assistant UEs to act as relays for supporting ranging service in non-LoS conditions.

Conventional solutions are provided by 3GPP SA2. For example, in TR 23.700-86 v 1.2.0, architecture enhancements to support ranging-based and SL positioning services. In particular, the following definitions are provided:
SL positioning: positioning UEs using reference signals transmitted over SL, i.e. a PC5 interface, to obtain absolute position, relative position, and/or ranging information.
Ranging: refers to the determination of the distance between two or more UEs and/or of the direction of one UE (i.e. the target UE) from another UE (i.e., a reference UE) via a PC5 interface.
A target-UE may be referred to as a UE of interest, whose position (absolute or relative) is to be obtained by the network or by the target UE itself.
Anchor/reference UE: a UE that supports positioning of the target UE, e.g. by transmitting and/or receiving reference signals for positioning, providing positioning-related information, etc., over the SL interface. The anchor/reference UE may also be referred to as a SL reference UE.
Assistant UE: a UE that supports ranging/SL positioning between a SL reference UE and a target UE over PC5, when direct ranging/SL positioning between the SL reference UE/anchor UE and the target UE cannot be supported. The measurement/results of the ranging/SL positioning between the assistant UE and the SL reference UE, and the measurement/results of the ranging/SL positioning between the assistant UE and the target UE, are determined and used to derive the ranging/SL positioning results between the target UE and the SL reference UE.
SL positioning server UE: a UE that offers location server functionality in lieu of a LMF, for SL positioning and ranging over SL. It interacts with a target UE, reference UEs, assistant UE and located UEs as necessary in order to calculate the location of the target UE.
SL positioning client UE: A third-party UE, other than the SL reference UE and the target UE, which initiates a ranging/SL positioning service request on behalf of the application residing on it.
Located UE: A SL reference UE whose location is known or is able to be determined using Uu based positioning. A located UE can be used to determine the location of a target UE using SL positioning.

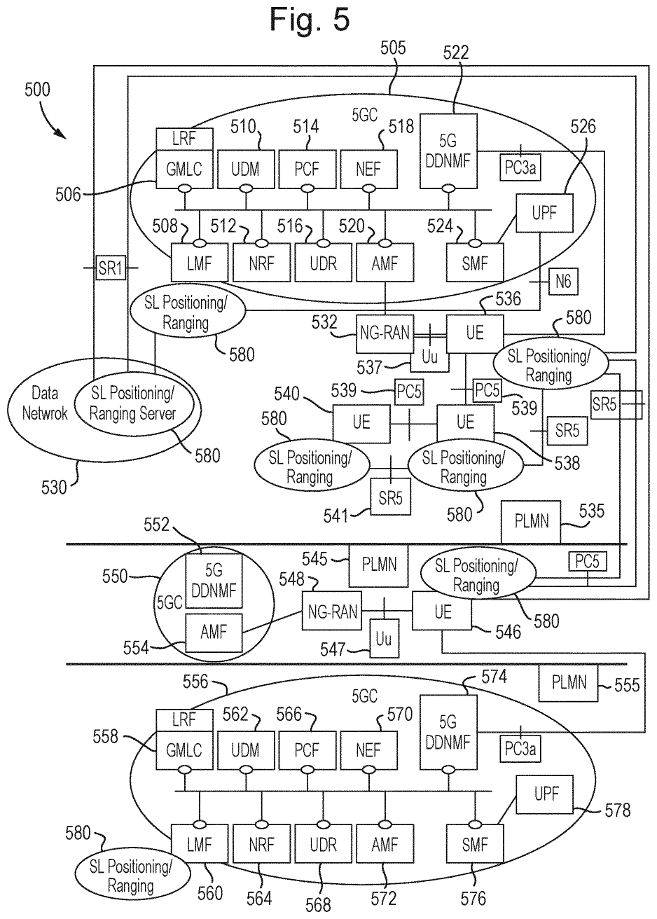

FIG. 5 depicts a SA2 architecture 500 for SL positioning support. A general SA2 architecture for SL positioning support is provided in 3GPP TR 23.700-86 v 1.2.0. The SA2 architecture 500 comprises a first 5G core (5GC) 505. The first 5GC 505 comprises a Gateway Mobile Location Centre (GMLC) 506, a LMF 508, a Unified Data Management (UDM) 510, a Network Repository Function (NRF) 512, a Policy Control Function (PCF) 514, a Unified Data Repository (UDR) 516, a Network Exposure Function (NEF) 518, a first AMF 520, a first 5G Direct Discovery Name Management Function (DDNMF) 522, a Session Management Function (SMF) 524, and a User Plane Function (UPF) 526.

The first 5GC 505 is communicatively coupled to a data network 530 via a N6 interface with the UPF 526.

The first 5GC 505 is communicatively coupled, via the AMF 520, to a first Next Generation Radio Access Network (NG-RAN) 532 of a first Public Land Mobile Network (PLMN) 535. The first PLMN 535 further comprises a first UE 536 communicatively coupled to the NG-RAN 532 via a Uu interface 537, a second UE 538 communicatively coupled to the first UE 536 via a PC5 interface 539, and a third UE 540 communicatively coupled to the second UE 538 via a further PC5 interface 541.

The SA2 architecture 500 further comprises a second PLMN 545 in which a fourth UE 546 is communicatively coupled via a Uu interface 547 to a second NG-RAN 548. The second NG-RAN 548 is communicatively coupled to a second 5GC 550 which comprises a second 5G Direct Discovery Name Management Function (DDNMF) 552 and a second AMF 554.

The SA2 architecture 500 further comprises a third PLMN 555 in which resides a third 5GC 556. The third 5GC 556 comprises a second Gateway Mobile Location Centre (GMLC) 558, a second LMF 560, a second UDM 562, a second NRF 564, a second PCF 566, a second UDR 568, a second NEF 570, a third AMF 572, a third 5G DDNMF 574, a second SMF 576, and a second UPF 578.

The third 5GC 556, and in particular the third 5G DDNMF 574, is communicatively coupled to the third UE 540 via a PC3a interface.

Each of the first LMF 508, the data network 530, the first UE 536, the second UE 538, the third UE 540, the fourth UE 546, and the second LMF 560 comprises a respective SL positioning/ranging server 580.

In non-mission critical scenarios, according to 3GPP SA6 SEAL has specified a Location Management (LM) layer (in similar manner as in Management Client scenarios). The SEAL LM layer provides support for vertical industries. However, the actual use of the SEAL/LM layer is specified in relevant vertical-specific SA6 studies.

The LM server is a functional entity that receives and stores user location information and provides user location information to the vertical application server. The LM server may also acquire location information provided by a PLMN operator via a T8 reference point. The LM server acts as a Common API Framework's (CAPIF's) API-exposing function, as specified in 3GPP TS 23.222 v 17.7.0. The LM server also supports interactions with the corresponding LM server in distributed SEAL deployments.

The LM client (LMC) acts as the application client for LM functions. It interacts with the LM server. The LMC also supports interactions with the corresponding LMC between the two UEs.

There are two existing architecture options for on-network and off-network support.

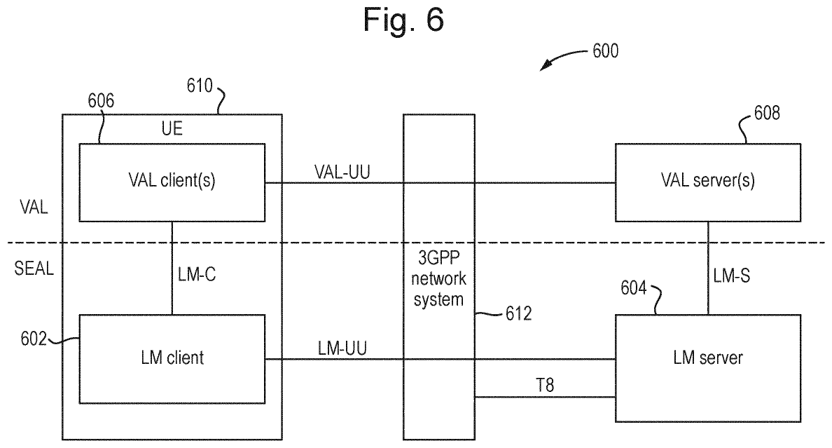

FIG. 6 depicts an on-network functional model 600 for LM. In the on-network functional model 600, a LM client 602 communicates with a LM server 604 over a LM-UU reference point 605. The LM client 602 provides the support for LM functions to a VAL client(s) 606 over a LM-C reference point 607. A VAL server(s) 608 communicates with the LM server 604 over a LM-S reference point 609. The LM server 604 communicates with the Service Capability Exposure Function (SCEF) 610 via a T8 reference point 611 to obtain location information from the underlying 3GPP network system 612.

The VAL server(s) 608 can be the application specific server (e.g. a Platooning server) or vertical specific enabler server (e.g. a VAE).

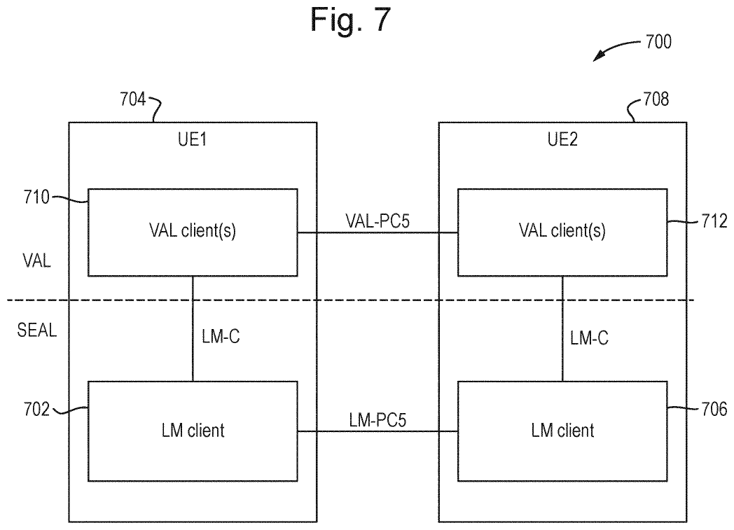

FIG. 7 depicts an off-network functional model 700 for LM. For the off-network functional model 700, a first LM client 702 of a first UE 704 communicates with a second LM client 706 of a second UE 708 over a LM-PC5 reference point 709.

A first VAL client 710 of the first UE 704 is communicatively coupled to the first LM client 702 via a first LM-C interface 711. A second VAL client 712 of the second UE 708 is communicatively coupled to the second LM client 706 via a second LM-C interface 713. The first VAL client 710 and the second VAL client 712 are communicatively coupled via a VAL-PC5 interface 715.

In 3GPP TS 23.434 v 18.2.0, some procedures with SA6 impact have been captured. To summarize, the following procedures have been outlined:
1. Event-triggered location reporting procedure: the LMS provides location reporting configuration to the LM clients, indicating the information the LM server expects and the events which will trigger the sending of this information to the LM server. The decision to report location information can be triggered at the client by different conditions, e.g. the reception of the location reporting configuration, initial registration, distance travelled, elapsed time, cell change, etc.
2. On-demand location reporting procedure: the LM server can request UE location information at any time by sending a location information request to the LM client, which may trigger the LM client to immediately send the location report.
3. Client-triggered or VAL server-triggered location reporting procedure.
4. Location reporting triggers configuration cancel.
5. Location information subscription procedure.
6. Event-trigger location information notification procedure.
7. On-demand usage of location information procedure: The VAL server can request UE location information at any time by sending a location information request to the LM server, which may trigger the LM server to immediately send the location report.
8. Obtaining UE(s) information at a location: the LMS can provide the UE information for a target location based on a VAL server request.
9. Monitoring Location Deviation: the LMS can monitor the location of the VAL UE in relation to an area of interest. LMS server evaluates the current location of the VAL UE in relation to the area of interest configured by the VAL server. If subscribed, the VAL server is notified by the LMS server when the VAL UE relationship with (e.g. inside or outside) the area of interest changes along with current location information of the VAL UE.
10. Location area monitoring information procedure: the VAL server can subscribe to the LMS to get the list of UEs moving into or moving out of the specific location area.

The present disclosure provides a mechanism for configuring and provisioning via application layer information on the entities to be used and their responsibilities for a ranging/SL positioning service. This solution assumes that the UEs of different capabilities and potential roles (e.g., reference, target, assistant) have instantiated a location enablement client (LMC) or such logic is embedded in the application clients using ranging services.

Hence, it is possible that the VAL client (AC) interacts with SEAL LMS, or that the VAL client (AC) uses SEAL LMC to interact with LMS. The former is not yet supported but can be made possible via a Subscriber-aware Northbound Access (SNA) framework.

The entities involved in this mechanism are as follows:
A SL positioning server at the data network (DN) side.
A first UE acting as a reference UE or anchor UE (or a located UE, in the case in which the location of the reference UE is known).
A second UE acting as a target UE.
A third UE acting as an assistant UE.
A fourth UE acting as a client UE (if the request for SL positioning comes from another UE).
A SL Positioning Application which may have two forms.
   A SL Positioning server UE: a UE which offers location calculation.
   A SL Positioning client UE: a third-party UE, other than a SL reference UE and target UE, which initiates ranging/SL positioning service request on behalf of the application residing on it.
A SL positioning enabler at LMS or any other enabler server which is authorized/delegated by the SL positioning server to support the provisioning/delivery of ranging services in an area.
An LMC per each involved UE, or per each of a subset of the UEs (some UEs may be grouped and the LMC can be only at the group head). Alternatively, the logic of the LMC may be embedded at the Application Client (using the ranging service), which can thus play the role of the SL Positioning server UE or SL Positioning client UE.

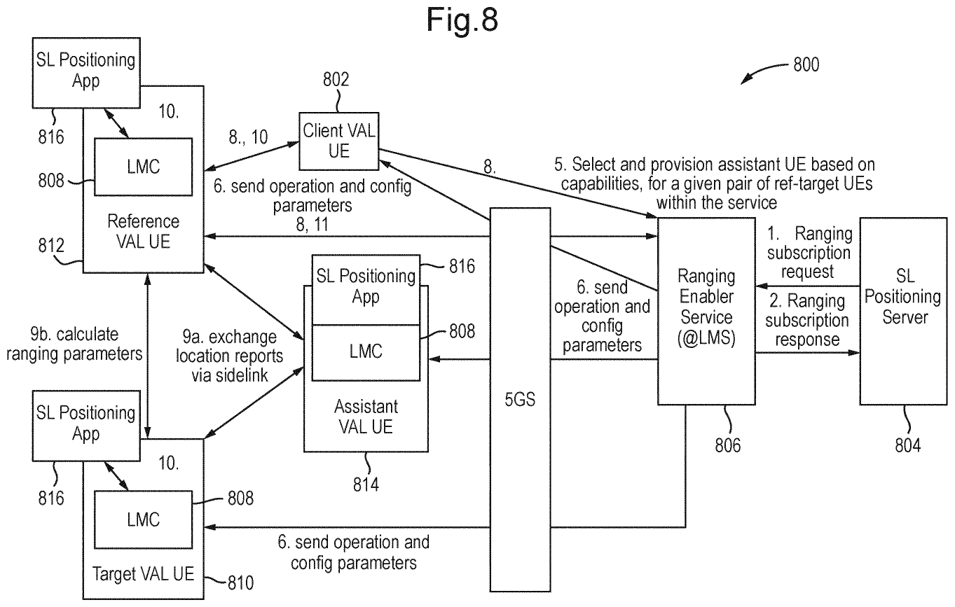

FIG. 8 depicts a SL positioning enablement service architecture 800. The SL positioning enablement service architecture 800 comprises a client UE 802, a SL positioning server 804, a LMS 806, and respective LMCs 808 belonging to a target UE 810, a reference UE 812, and an assistant UE 814. Each of the target UE 810, the reference UE 812, and the assistant UE 814 is provided with a respective SL positioning application 816. The architecture 800 further comprises a 5G system (5GS) 818.

As one pre-condition, the one or more client UEs 802 send a “discovery” request to the SL positioning server 804 (in case the location of the client UE 802 needs to be discovered).

As indicated by reference numeral 821, the SL positioning/ranging server 804 sends a subscription request to the LMS 806 to provision and manage ranging operation and configurations. This includes monitoring, discovering of UEs assisting the operation, and delivering the configuration for a target service area, or for a target set of UEs to serve as reference and target. This request may also include a list of client UEs whose location needs to be discovered (based on the request of the client UE 802).

As indicated by reference numeral 822, The LMS 812 sends a subscription response to the SL positioning/ranging server 804. And SL positioning/ranging server may also send a response/acknowledgement to the client UE 802 (out of scope).

The LMS 806 finds all the LMCs 808 in the target service area, and categorizes them by their capabilities as target UE 810, reference UEs 812, assistant UE 814 or even located UEs (e.g., if reference UE location is known or in out-of-coverage scenarios). The identification of UEs in a target area may be executed via existing SEAL LMS procedures.

The LMS 806, after getting all UE information in the target area, calculates the relative distances among them, and may also request/receive HDMaps for the target area (e.g., from other VAL servers or a VAE server). This will help to identify LoS or NLOS situations. The LMS 806 may also evaluate the need of assistant UE(s) for each of the pairs of reference-target UEs.

The LMS 806 evaluates the need for an assistant UE, and if an assistant UE is needed due to there being no direct link, or expected or predictive relative positioning causing low quality in direct communication (e.g., in the case in which a UE mobility pattern or predictive UE location is known), the LMS 806 selects the appropriate UE to serve as assistant (considering also the UE capabilities) and configures the assistant UE 814 with information, thresholds etc., one-time or period ranging, ranging for distance or direction measurement, or both. The assistant UE 814 is also configured with configuration of delivery, e.g. the transmission mode (unicast, broadcast, groupcast), and configuration as to how to process location reports and create ranging parameters, and distribute said reports.

As indicated by reference numerals 826, the LMS 806 configures LMCs 808 with all the configuration information obtained previously, and in particular with the expected responsibility in relation ranging/SL positioning application service.

More specifically, the assistant UE 814 is notified that it will serve as a relay and needs to confirm.

The client UE 802 is also provisioned with a list of ranging UEs/assistant UEs, so as to be aware of these entities when the client UE 802 requests ranging parameters from the LMS 806 or from the reference UE 812.

As indicated by the reference numeral 827, the LMCs 808 interact with the VAL clients and other LMCs 808 (not reachable by the LMS 806) to convey the configuration.

Ranging Service gets initiated from the App of the client UE. As indicated by the reference numeral 828, the client UE 802 requests via the LMC 808 ranging information, from the LMS 806 (or from the reference UE 812 if the LMS 806 is out of coverage), between the reference UE 812 and the target UE 810.

Here it is possible that the client UE 802 has already discovered SL reference/assistance UE using ProSe discovery. That is, the client UE 802 is configured with ProSe discovery codes.

It can also be possible that the client UE 802 receives the reference/assistant UE discovery information (ID, address, etc.) from the SEAL LMS 806 based on the configuring at 826. Or, alternatively, it is possible that this discovery happens after configuration, at the operation phase.

As indicated by the reference numeral 829, the LMS 806 interacts with the reference UE 812 (or the assistant UE 814) to derive ranging parameters at the corresponding LMC 808 or SL positioning server UE application 816, after receiving location reports from the involved entities via LM-C. In the case in which the UE is out of coverage of the LMS 806, LMS interaction is not needed.

As indicated by the reference numeral 830, the LMCs 808 report the ranging information to the client UE 802 and the respective SL positioning applications.

As indicated by the reference numeral 831, the LMC 808 provides a late notification to the LMS 806.

Embodiments of the present invention include implementations related to 1) VAL subscription and configuration of SL positioning/ranging service parameters, and 2) for SL positioning operation for in-coverage and out-of-coverage scenarios (based on the configuration).

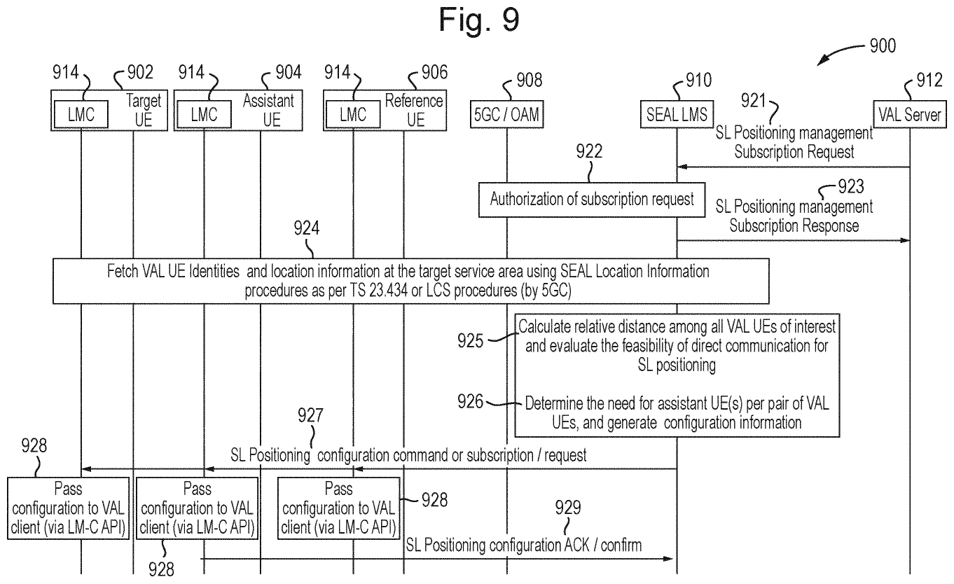

FIG. 9 depicts a messaging diagram 900 for carrying out subscription and configuration for SL positioning management. The architecture for carrying out the steps depicted by the messaging diagram 900 comprises a target UE 902, a candidate assistant UE 904, a reference UE 906, a 5GC/OAM system 908, a SEAL LMS 910, and a VAL server 912. Each of the target UE 902, the candidate assistant UE 904, and the reference UE 906 comprises a respective LMC 914.

Here, a SL positioning enabler server is a part of the SEAL LMS 910; however, it is possible that such capability resides in another enabler (as defined in SA6, e.g. a FLS) or an application function (AF) for performing the configuration enablement (instead of the SEAL LMS 806).

As indicated by the reference numeral 921, the VAL server 912 sends to the SEAL LMS 910 a SL positioning (or ranging) management subscription request. This can, in some embodiments, be in the form of a request, e.g. a message. This subscription/request delegates/assigns to the SEAL LMS 910 the task of configuring/provisioning and delivery of information required for the SL positioning/ranging service. For example, the VAL server 912 can be a IOT server or a V2X server requiring the provisioning and monitoring of SL positioning communication aspects from the SEAL LMS 910. This message includes at least some of the information described in Table 1.

TABLE 1
information elements of a management subscription request.

| Information element | Description |
|---|---|
| Identity | Identity of the requesting VAL server/VAL user or |
| | VAL UE (in case of a VAL user subscribing). |
| SL Positioning service ID | Identity of the VAL service (SL positioning service) |
| | for which the location information is subscribed. |
| > SL Positioning service area | The geographical area/zone or topological area |
| | (e.g. cells) for which the subscription applies. This |
| | can also be in the form of a Zone ID. |
| > VAL UE/user Identities list | List of VAL users or VAL UEs participating at the |
| | SL positioning service (reference and target VAL |
| | UEs). |
| > VAL preference / policies | The VAL policies or preferences related to the |
| | communication among the VAL UEs (e.g. |
| | transmission mode, direct vs network-assisted SL |
| | positioning). Such policies may also include the SL |
| | positioning parameters to be reported (e.g. |
| | distance, direction or both), their frequency, and |
| | the permission/exposure level to the VAL UEs in |
| | the target area. |
| > List of candidate assistant UEs | VAL server can also provide a list of UEs which |
| | can be allowed to server as assistant UEs. |
| > VAL UE ranging capabilities | The capabilities of the VAL UEs of interest (if |
| | provided) with respect to ranging/SL positioning |
| | capabilities. |
| > List of Client UE IDs and | The identities of the client UEs which are allowed |
| addresses | to get ranging information for other UEs. |
| >> Capability exposure level | The permissions / exposure level for the client UEs |
| | (what is allowed to be exposed to them and if some |
| | anonymization is needed). |
| Reporting configuration | It indicates the threshold and interval time between |
| | consecutive reports. |
| Triggering criteria | If reporting is expected to happen based on certain |
| | conditions in future instance, this IE provides |
| | information on the conditions to trigger some |
| | reporting (e.g. high load scenarios, feasibility of |
| | direct links, high number of re-Tx). |

As indicated by the reference numeral 922, the SEAL LMS 910 authorizes the subscription request with the OAM/charging system 908 or with a SEAL provider management domain.

As indicated by the reference numeral 923, the SEAL LMS 910 sends to the VAL server 912 a SL positioning/ranging management subscription response and indicates the subscription result.

As indicated by the reference numeral 924, the SEAL LMS 910 shall use the location information procedures as specified in clause 9.3.7, 9.3.10 and clause 9.3.12, of 3GPP TS 23.434 v 18.2.0, to periodically obtain the VAL UE location information at the target area or based on the request made at 921 (if the UEs are indicated). Based on the geographic information from the VAL server 912, the LMS server may determine to additionally include the positioning methods in SEAL LMS procedures to obtain location information.

As indicated by the reference numeral 925, the SEAL LMS 910 calculates ranging parameters (e.g., distance and/or direction) for each pair of reference-target UEs, as well as for other involved UEs.

As indicated by the reference numeral 926, the LMS 910 stores these calculations and evaluates the need of the assistant UE 904, and if the assistant UE 904 is needed due to there being no direct link or low quality in expected or predictive relative positioning in direct communication (in the case in which the UE mobility pattern or predictive UE location is known), the LMS 910 selects the appropriate UE to serve as assistant (considering also the capabilities of the UE) and configures the so-selected assistant UE 904 with information, thresholds, one time or period ranging, ranging for distance or direction measurement or both, etc. Also, configuration of delivery, for example the transmission mode (unicast, broadcast, groupcast) and how to process location reports and create ranging parameters, and distribute the same, may be provided by the LMS 910. More specifically, the LMS 910 may configure the LMCs 914 with all of the configuration information and, in particular, the expected responsibility with respect to the ranging/SL positioning application service. This configuration information may include an assistant UE flag, and, for each pair of reference-target UE, the Assistant UE IDs, capabilities (e.g., L3 or application relay), and addresses.

This configuration information is also sent to authorized UEs, thereby to select the UE(s) to serve as a client UE to be further provisioned with ranging UEs/assistant UEs 904, so as to make the client UE aware of the entity when it needs to request from a ranging parameter the LMS 910 or from the reference UE 906.

As indicated by the reference numeral 927, the SEAL LMS 910 sends the configuration either as a request (e.g., for assistant UEs to provide confirmation), or as a subscription, or as a command. This step can also be split into a SL positioning subscription/request from the SEAL LMS 910 to LMCs 914, and then transmission of notification/response information from the respective LMCs 914 to the LMS 910, to allow passing of the configuration information to the LMCs 914 of the VAL UEs of interest (or of all UEs within the area of interest).

The configuration information may include at least some of the elements described in Table 2 below.

TABLE 2
possible information elements in the configuration information.

| Information element | Description |
|---|---|
| Identity | The identity of the requesting SEAL server or the |
| | subscriber VAL server. |
| SL Positioning service ID | The identity of the VAL service (SL positioning |
| | service). |
| >SL Positioning service area | The geographical area /zone or topological area |
| | (e.g. cells) for which the subscription applies. This |
| | can also be in the form of a Zone ID. |
| > VAL UE/user Identities list | List of VAL users or VAL UEs participating in the |
| | SL positioning service (reference and target VAL |
| | Ues). |
| Ranging configuration | |
| parameters | |
| > Reference and target UE ID | The VAL server can also provide a list of UEs |
| and address | which can be allowed to server as assistant UEs |
| >> Assistant UE | |
| ID(s) and mapping | |
| >> VAL UE ranging capabilities | The capabilities of the VAL UEs of interest (if |
| | provided) with respect to ranging/SL positioning |
| | capabilities |
| >> SL configuration | The access / transmission policies / parameters, |
| policies/parameters | which can be similar to ProSe parameters as in TS |
| | 23.304. |
| > List of Client UE IDs and | The identities of the client UEs which are allowed |
| addresses | to get ranging information for other UEs |
| >> capability exposure level | The permissions / exposure level for the client UEs |
| | (what is allowed to be exposed to them and if some |
| | anonymization is needed) |
| > allowable transmission modes | Whether unicast or groupcast or broadcast is |
| | expected as transmission mode for the |
| | communication between two or more UEs within |
| | the ranging application service/ SL positioning |
| | service. |
| > configuration for out of | Means of communication / reporting in out of |
| coverage scenarios | coverage, e.g. who can be the anchor / located UE |

> reserved resources and UE roles for ranging service

| | |
|---|---|
| Reporting configuration | It indicates the threshold and interval time between |
| | consecutive reports |
| Triggering criteria | If reporting is expected to happen based on certain |
| | conditions in future instance, this IE provides |
| | information on the conditions to trigger some |
| | reporting (e.g. high load scenarios, feasibility of |
| | direct links, high number of re-Tx) |

As indicated by the reference numeral 928, the LMCs 914 interact with the respective VAL clients, e.g. via LM-C API, to provide the configuration information.

As indicated by the reference numeral 929, the LMCs 914 send a response or ACK or subscription response to the LMS 910 based on the type of message received at step 927.

### Embodiment 2: SL Positioning Operation Phase

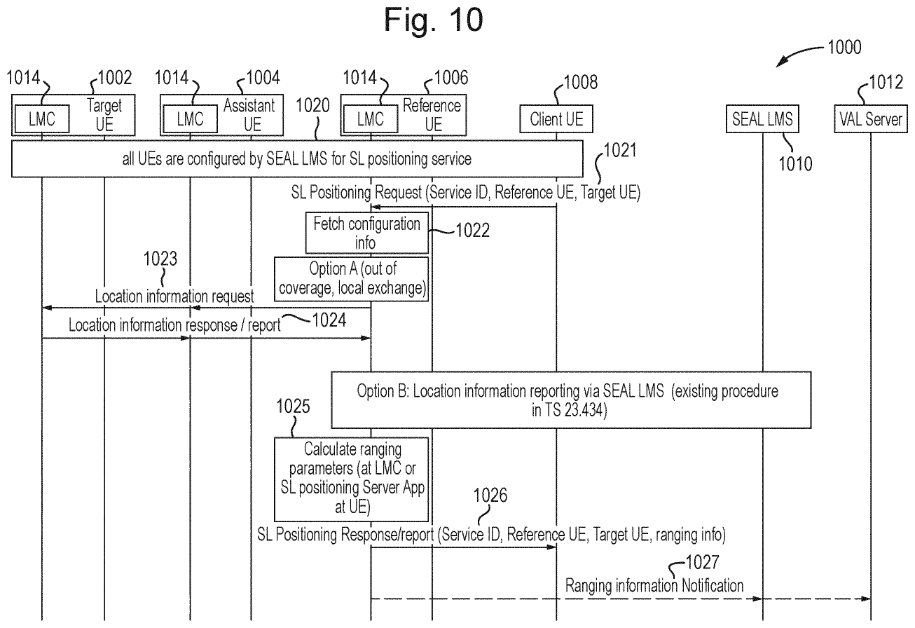

FIG. 10 is a messaging diagram 1000 depicting the steps for carrying out an SL positioning operation phase in both in-coverage and out-of-coverage scenarios. The architecture for carrying out the steps depicted by the messaging diagram 1000 comprises a target UE 1002, a candidate assistant UE 1004, a reference UE 1006, a client UE 1008, a SEAL LMS 1010, and a VAL server 1012. Each of the target UE 1002, the candidate assistant UE 1004, and the reference UE 1006 comprises a respective LMC 1014.

The operation is assumed to be triggered by the client UE 1008 which is a further UE which requests the ranging information; however, it is also possible that this is triggered by the reference UE 1006 or the SEAL LMS 1010/VAL server 1012/VAL client.

As indicated by the reference numeral 1020, all UEs are configured with SL positioning/ranging configurations as outlined above with reference to FIG. 9.

The client UE 1008 discovers the reference UE 1006 using the ProSe discovery mechanism or based on the configuration (reference UE information and ProSe application codes can be provided by the LMS 1010). A ProSe Application Code is defined in 3GPP TS 23.303 v 17.0.0. The ProSe Application Code may be associated with the ProSe Application Identity (ID) and may be used in the open ProSe Direct Discovery procedures. The ProSe Application ID is an identity used for open ProSe Direct Discovery. The ProSe Application ID may identify application related information for a ProSe-enabled UE.

As indicated by the reference numeral 1021, the client UE 1008 (e.g., via its LMC or VAL client) sends a request to the LMC 1014 of the reference UE 1006 to get ranging information (e.g., direction, distance) for the reference UE 1006 and the target UE 1002. This request includes the service ID, the UE IDs (of reference and target UEs) and addresses, as well as the use of the assistant UE 1004 (optionally) and its ID/address and capabilities.

As indicated by the reference numeral 1022, the LMC 1014 fetches the configuration information for the given service and a pair of reference-target UEs 1002, 1006, based on the procedure described above with respect to FIG. 9. The LMC 1014 also fetches the exposure level/permissions of the client UE 1008, thereby to indicate what information should be, and how it should be exposed (e.g., whether only distance, or further info, should be sent).

In certain embodiments, the reference UE discovers the Assistant/Target UEs using the ProSe discovery mechanism or based on the configuration (assistant/target UE information and ProSe application codes can be provided by LMS)

In the case in which the LMS 1010 is out of coverage, or if indicated at the configuration, the LMCs 1014 may interact without the LMS 1010 intervention.

As indicated by the reference numeral 1023, the reference UE 1006 via its LMC 1014, sends a location information request to the target UE 1002 directly, or via the assistant UE 1004. This request may include the list of VAL users or VAL UEs whose location information is requested and/or the identity of the VAL service for which the location information is requested. This may also include the accuracy and/or granularity of location, and whether this is a one-time request or if periodic reporting is needed.

As indicated by the reference numeral 1024, the reference UE 1006 via its LMC 1014 receives a location information report/response from the target UE via the assistant or directly, to provide its location with the requested accuracy/granularity.

Alternatively to 1023 and 1024, the LMC 1014 of reference UE 1006 may also send a request to the SEAL LMS 1010 or to the 5GC (via SNA) to get the location information for the UEs of interest (as per TS 23.434 v 18.2.0).

As indicated by the reference numeral 1025, the reference UE 1006 (the LMC 1014 or the SL positioning server/client app which may be similar to the VAL client) calculates the relative distance, direction and/or any further ranging information that is requested.

As indicated by the reference numeral 1026, the LMC 1014 of the reference UE 1006 sends a SL positioning response to provide the report including the service ID and the ranging information for the reference UE 1006 and the target UE 1002.

As indicated by the reference numeral 1027, the LMC 1014 of the reference UE 1006 may also send a notification to the SEAL LMS 1010 to provide ranging information (to be used for updating the estimated calculation at the LMS 1010 or to be used as statistics) and also to inform the LMS 1010 as to the success/failure of the request/response transaction. The LMS 1010 may also notify the VAL server 1012 as to the ranging information and result.

In a further embodiment, there is provided an implementation which covers the case in which the SL positioning enabler/LMS, after discovering the UEs in an area and selecting/configuring the reference/assistant UEs, allows the respective UEs to interact with ProSe function, thereby to announce their capabilities.

The ProSe Function is a logical function that may be used for network related actions required for ProSe. The ProSe Function plays different roles for each of the features of ProSe. The ProSe Function consists of three main sub-functions that perform different roles depending on the ProSe feature:
Direct Provisioning Function (DPF) is used to provision the UE with necessary parameters in order use ProSe Direct Discovery and Prose Direct Communication. It is used to provision the UEs with PLMN specific parameters that allow the UE to use ProSe in this specific PLMN.
Direct Discovery Name Management Function is used for open Prose Direct Discovery to allocate and process the mapping of ProSe Applications IDs and ProSe Application Codes used in ProSe Direct Discovery.
EPC-level Discovery ProSe Function has a reference point towards the Application Server (PC2), towards other ProSe Functions (PC6), towards the HSS (PC4a) and the UE (PC3).

This implementation may be considered a variant/simplification of the procedure depicted by the messaging diagram 900 and described above with reference to FIG. 9, and includes the following steps:

As a pre-condition, a SL positioning/ranging service provider will have subscribed to the SEAL LMS for ranging enablement services (as in the embodiment of FIG. 9).

At a first step, a SL positioning enabler/LMS discovers, initially or periodically, the UEs in a target area, where the target area is defined based on the SL positioning/ranging service provider's initial request/subscription. Such discovery may use the location information procedures as specified in clause 9.3.7, 9.3.10 and clause 9.3.12 of 3GPP TS 23.434 v 18.2.0, to periodically obtain the VAL UE location information at the target area.

At a second step, based on the discovered list of UEs in the target area, the SL positioning enabler/LMS decides and selects which UEs are going to serve as reference or assistant UEs, based on their location and capabilities.

At a third step, upon executing the second step, optionally the LMS may send a request to the SL positioning/ranging service provider to confirm the selection of the UEs (this may be possible based on the service agreement between SEAL provider and SP), and the LMS receives a response indicating a confirmation.

At a fourth step, the LMS may configures the UEs to serve as reference UEs and assistant UEs for the target area and application. The configuration may be similar to that described above with reference to FIG. 9, and may include the service ID, UE IDs, UE roles, area(s) of interest, transmission modes, resource/spectrum considerations, interface selection (e.g., NR-PC5, LTE-PC5), etc.

At a fifth step, the reference and/or assistant UEs request a code from the ProSe function to announce that it/they is/are an assistant or reference UE.

At a sixth step, the ProSe function authorizes the requests and reference and/or assistant UEs receive a code from the ProSe function to announce that it/they is/are an assistant or reference UEs.

Accordingly, there is provided a location management entity for a ranging application service, the location management entity comprising a processor; and a memory coupled with the processor. The processor is configured to cause the location management entity to: obtain information associated with location of a plurality of user equipments; evaluate in respect of a pair of user equipments from the plurality of user equipments based on the obtained information associated with location of the pair of user equipments, whether there exists a requirement for utilizing a further user equipment to assist in the ranging application service. If the further user equipment is required to be utilized, then the processor is further arranged to select the further user equipment based on information associated with location of the further user equipment; and send at least one side-link positioning configuration information to the pair of user equipments and the further user equipment.

The location management entity may be a Location Management Server. The location management entity may manage, support, and/or control the ranging application service. The ranging application service can be also referred to as a ranging service or can be one possible implementation of a sidelink positioning service. A sidelink positioning service may comprise a service providing means to improve UE positioning, where a positioning reference signal transmission and measurement are performed on a sidelink. The positioning reference signal transmission and measurement may also be performed on PC5 interface.

Information associated with the location of the further UE can be the location information with different granularities (e.g. coordinates, civic address, cell), and also this can be the actual or expected or predicted location of the UE. In certain embodiments, the information may comprise mobility information or the mobility pattern of the UE and a set of waypoints for an expected UE route.

The location management entity may comprise a location management server. The ranging application service may provide ranging information between the pair of user equipments. The ranging information may comprise information relating to the distance between two user equipments or more user equipments and/or the direction of one user equipment (i.e. Target user equipment) from another user equipment (i.e. Reference user equipment). Such ranging may be determined via a PC5 interface. A side-link positioning configuration information may comprise a configuration parameter related to positioning a user equipment using PC5 to obtain absolute position, relative position, or ranging information. The positioning may comprise sidelink positioning and/or ranging information. The step of determining ranging information for a pair of user equipments of the plurality of user equipments may comprise determining ranging information for a set of user equipments of the plurality of user equipments. The set of user equipments may comprise a plurality of the plurality of user equipments. The further user equipment may be an assistant user equipment or a target user equipment.

Such a location management entity tends to facilitate efficient support of the sidelink positioning/ranging service operation and continuity, and in particular how to select, configure and provision assistant user equipments to act as relays for supporting ranging service in non-Line of Sight (nLoS) conditions.

The location management entity may be further arranged to receive a request from an application server to provision side-link positioning configuration information for the ranging application service.

The side-link positioning configuration information may comprise at least one of: the identity and address for each of the pair of user equipments; the identity of the further user equipment; user equipment ranging capabilities; side-link configuration policies and/or parameters; a list of client user equipments and addresses; a capability exposure level; an allowable transmission mode; a configuration for out of coverage scenarios; and/or a list of user equipments participating in the ranging application service. The list of user equipments participating in the ranging application service may include at least one reference user equipment and at least one target user equipment.

The location management entity may be further arranged to select the further user equipment based on the location information and a capability of a further user equipment.

The location management entity may be further arranged to send a request to the application server that confirms the selection of further user equipment.

The at least one side-link positioning configuration information may comprise information to enable an interaction with a proximity function. The proximity function may be a 3GPP Proximity-based Service (ProSe). The interaction with the proximity function may comprise allowing one of the pair of user equipments and the further user equipment to announce their capabilities as reference and assistant user equipments respectively.

The location management entity may be further arranged to configure a list of user equipments participating at the ranging application service. The configuring may comprise at least one of the service identity, user equipment identity, user equipment role, area of interest, transmission mode, resource/spectrum considerations, and/or interface selection (NR-PC5, LTE-PC5), or some combination thereof. Configuring a list of user equipments participating at the ranging application service may comprise configuring a list of user equipments participating at the ranging application service for any combination of a target area and a target application.

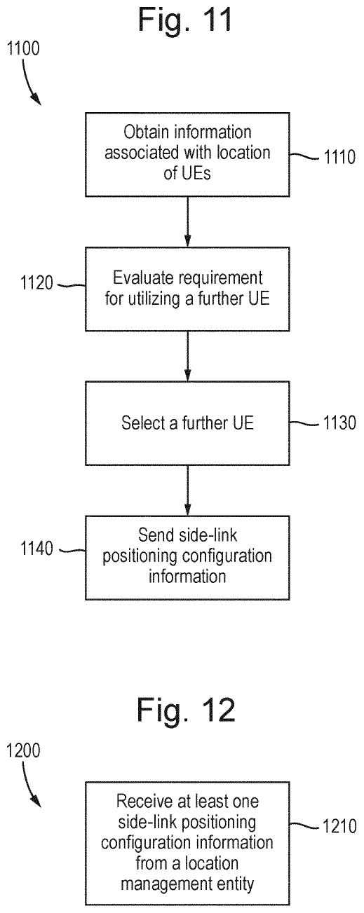

FIG. 11 illustrates a method 1100 of performing a ranging application service by a location management entity, the method 1100 comprising: obtaining 1110 information associated with location of a plurality of user equipments; evaluating 1120 in respect of a pair of user equipments from the plurality of user equipments based on the obtained information associated with location of the pair of user equipments, whether there exists a requirement for utilizing a further user equipment to assist in performing the ranging application service; and if the further user equipment is required to be utilized, selecting 1130 the further user equipment based on information associated with location of the further user equipment; and sending 1140 at least one side-link positioning configuration information to the pair of user equipments and the further user equipment.

In certain embodiments, the method 1100 may be performed by a processor executing program code, for example, a microcontroller, a microprocessor, a CPU, a GPU, an auxiliary processing unit, a FPGA, or the like.

The location management entity may comprise a location management server. The ranging application service may provide ranging information between the pair of user equipments. The ranging information may comprise information relating to the distance between two user equipments or more user equipments and/or the direction of one user equipment (i.e. Target user equipment) from another user equipment (i.e. Reference user equipment). Such ranging may be determined via a PC5 interface. A side-link positioning configuration information may comprise a configuration parameter related to positioning a user equipment using PC5 to obtain absolute position, relative position, or ranging information. The positioning may comprise sidelink positioning and/or ranging information. The step of determining ranging information for a pair of user equipments of the plurality of user equipments may comprise determining ranging information for a set of user equipments of the plurality of user equipments. The set of user equipments may comprise a plurality of the plurality of user equipments. The further user equipment may be an assistant user equipment or a target user equipment.

Such a method tends to facilitate efficient support of the sidelink positioning/ranging service operation and continuity, and in particular how to select, configure and provision assistant user equipments to act as relays for supporting ranging service in non-Line of Sight (nLoS) conditions.

The method may further comprise receiving a request from an application server to provision side-link positioning configuration information for the ranging application service.

The side-link positioning configuration information may comprise at least one of: the identity and address for each of the pair of user equipments; the identity of the further user equipment; user equipment ranging capabilities; side-link configuration policies and/or parameters; a list of client user equipments and addresses; a capability exposure level; an allowable transmission mode; and/or a configuration for out of coverage scenarios; a list of user equipments participating in the ranging application service.

The list of user equipments participating in the ranging application service may include at least one reference user equipment and at least one target user equipment. The method may further comprise selecting the further user equipment based on the location information and a capability of a further user equipment. The method may further comprise sending a request to the application server, which confirms the selection of further user equipment.

The at least one side-link positioning configuration information comprises information to enable an interaction with a proximity function. The proximity function may be a 3GPP Proximity-based Service (ProSe). The interaction with the proximity function may comprise allowing one of the pair of user equipments and the further user equipment to announce their capabilities as reference and assistant user equipments respectively.

The method may further comprise configuring a list of user equipments participating at the ranging application service. The configuring may comprise at least one of the service identity, user equipment identity, user equipment role, area of interest, transmission mode, resource/spectrum considerations, and/or interface selection (NR-PC5, LTE-PC5), or some combination thereof. Configuring a list of user equipments participating at the ranging application service may comprise configuring a list of user equipments participating at the ranging application service for any combination of a target area and a target application.

There is further provided a user equipment operating as a reference user equipment or a further user equipment in a ranging application service area, the user equipment comprising: a processor; and a memory coupled with the processor, the processor configured to cause the user equipment to: receive at least one side-link positioning configuration information from a location management entity.

The reference user equipment may be one of a pair of user equipments. The side-link positioning configuration information may comprise information to enable an interaction with a proximity function.

The user equipment may be further arranged to: obtain proximity information from the proximity function for announcing a role in the ranging application service; and announce the role in the ranging application service.

The proximity information may comprise a ProSe application code. The role in the ranging application service may comprise further user equipment, reference user equipment, or target user equipment.

Where the user equipment is a reference user equipment, the reference user equipment may be further arranged to: receive a request for providing ranging information within the ranging application service area; determine information associated with location of a plurality of user equipments within the ranging application service area; and determine ranging information based on the determined information associated with location of the plurality of user equipments.

The ranging information may comprise information relating to the distance between two user equipments or more user equipments and/or the direction of one user equipment (i.e. Target user equipment) from another user equipment (i.e. Reference user equipment). Such ranging may be determined via a PC5 interface. The step of determining ranging information for a pair of user equipments of the plurality of user equipments may comprise determining ranging information for a set of user equipments of the plurality of user equipments. The set of user equipments may comprise a plurality of the plurality of user equipments.

The request may comprise a request for detecting a requirement for providing ranging information within the ranging application received from a client user equipment, allocation management entity or an application server. The user equipment may be further arranged to send the processed ranging information to a consumer of the ranging service.

The user equipment may be further arranged to send the processed ranging information to the location management entity.

Determining location information for a plurality of user equipments within the ranging application service may comprise: sending a location information request to a target user equipment, the request including a list of VAL users whose location information is requested and the identity of the VAL service for which the location information is requested; and receiving a location information report.

The VAL users may be VAL user equipments. The location information request may include the accuracy of location, the granularity and whether this is one time or if periodic report is needed. The location information request sent to the target user equipment may be sent via an assistant user equipment. The location information report may comprise a response from the target user equipment via the assistant user equipment or directly, to provide its location with the requested accuracy and/or granularity.

Determining location information for a plurality of user equipments within the ranging application service may comprise receiving location information via a further user equipment or a target user equipment. The pair of user equipments may comprise a reference user equipment and the target user equipment.

Determining location information for a plurality of user equipments within the ranging application service may comprise sending a request to a location management entity to obtain the location information for the target user equipments.

The network function may comprise a SEAL LMS or to the 5GC (via SNA).

FIG. 12 illustrates a method 1200 of a reference user equipment or a further user equipment in a ranging application service area, the method comprising receiving 1210 at least one side-link positioning configuration information from a location management entity.

In certain embodiments, the method 1200 may be performed by a processor executing program code, for example, a microcontroller, a microprocessor, a CPU, a GPU, an auxiliary processing unit, a FPGA, or the like.

The reference user equipment may be one of a pair of user equipments. The side-link positioning configuration information may comprise information to enable an interaction with a proximity function. The method may further comprise obtaining proximity information from the proximity function for announcing a role in the ranging application service; and announcing the role in the ranging application service. The proximity information may comprise a ProSe application code. The role in the ranging application service may comprise further user equipment, reference user equipment, or target user equipment. Where the method is of a reference user equipment, the method may further comprise: receiving a request for providing ranging information within the ranging application service area; determining information associated with location of a plurality of user equipments within the ranging application service area; and determining ranging information based on the determined information associated with location of the plurality of user equipments.

The ranging information may comprise information relating to the distance between two user equipments or more user equipments and/or the direction of one user equipment (i.e. Target user equipment) from another user equipment (i.e. Reference user equipment). Such ranging may be determined via a PC5 interface. The step of determining ranging information for a pair of user equipments of the plurality of user equipments may comprise determining ranging information for a set of user equipments of the plurality of user equipments. The set of user equipments may comprise a plurality of the plurality of user equipments.

The request may comprise a request for detecting a requirement for providing ranging information within the ranging application received from a client user equipment, allocation management entity or an application server.

The method may further comprise sending the processed ranging information to a consumer of the ranging service.

The method may further comprise sending the processed ranging information to the location management entity.

Determining location information for a plurality of user equipments within the ranging application service may comprise: sending a location information request to a target user equipment, the request including a list of VAL users whose location information is requested and the identity of the VAL service for which the location information is requested; and receiving a location information report.

The VAL users may be VAL user equipments. The location information request may include the accuracy of location, the granularity and whether this is one time or if periodic report is needed.

The location information request sent to the target user equipment may be sent via an assistant user equipment. The location information report may comprise a response from the target user equipment via the assistant user equipment or directly, to provide its location with the requested accuracy and/or granularity.

Determining location information for a plurality of user equipments within the ranging application service may comprise receiving location information via a further user equipment or a target user equipment. The pair of user equipments may comprise a reference user equipment and the target user equipment.

Determining location information for a plurality of user equipments within the ranging application service may comprise sending a request to a location management entity to obtain the location information for the target user equipments. The network function may comprise a SEAL LMS or to the 5GC (via SNA).

There is provided an application enablement entity (trusted third-party), and in particular a SEAL LMS, is enhanced to configure and provision ranging information to the users within a service area.

There is further provided an application enablement entity (trusted third-party), and in particular a SEAL LMS, determines whether an assistant UE is needed and how the ranging is performed via the assistant UE in both in-coverage and out-of-coverage scenarios.

There is further provided an application enablement entity (trusted third party), and in particular a SEAL LMS, delivers the configurations to all LMCs, and allows the LMCs to act autonomously to retrieve location information and process it on behalf of the application specific layer.

There is further provided a device application (LMC) applies the configurations, exchanges location information locally, and derives ranging information, based on the configuration received from the LMS.

There is further provided a reference or assistant UE is configured to interact with a ProSe function to get ProSe application codes and announce its role as a reference or assistant UE.

A problem solved by the arrangements described herein is that of how to support the discovery of UEs to support ranging services, and configuration and provision of policies/parameters related to SL positioning/ranging services from the service provider to the UEs (acting as reference, assistant, target UEs) meeting the ranging performance requirements.

Accordingly, there is further provided a mechanism for configuring and provisioning via application layer information on the entities to be used and their responsibilities for a ranging/SL positioning service. The decision of the communication means as well as the selection of the UEs acting as assistant and reference UEs is provided. Furthermore, the discovery, announcement and operation phase is described (including the out-of-coverage scenarios).

The prior art in SA2 assumes that a reference/assistant UE is selected and provisioning can happen in similar manner as in V2X/ProSe. Also, the prior art, in the case in which there is no direct link between reference and target, simply instructs us of an assistant UE; however, this approach may impact performance/connectivity, since the provider must guarantee the ranging KPIs and avoid service disruption due to UE mobility to out-of-reference-UE-reach. There is further provided an arrangement that allows the location tracking, pre-processing and configuration of parameters in a way that the ranging KPIs are assured.

There is further provided steps for subscription and configuration of SL positioning. Here the SL positioning enabler server is presented as part of the SEAL LMS.

There is further provided an operation phase in both in-coverage and out-of-coverage scenarios. The operation is assumed to be triggered by a client UE which is a further UE which requests the ranging information.

There is further provided an implementation which covers the case in which the SL positioning enabler/LMS, after discovering the UEs in an area and selecting/configuring the reference/assistant UEs, allows the respective UEs to interact with a ProSe function to announce their capabilities.

There is further provided a method at a location management server entity, the method comprising receiving a request to manage side-link positioning configuration information for a ranging application service. The method may further comprise discovering location information for a plurality of UEs within the ranging application service. The method may further comprise determining a requirement for utilizing a further UE for assisting the communication of the ranging application service. The method may further comprise determining at least one side-link positioning configuration parameter based on the request and the requirement for utilizing an assistant UE. The method may further comprise sending the at least one side-link positioning configuration parameter to a plurality of UEs within the ranging application service area.

The method may further comprise client UE triggering and client UE location discovery.

There is further provided a method at a location management client entity, the method comprising receiving at least one side-link positioning configuration parameter to a plurality of UEs within a ranging application service area. The method may further comprise detecting a requirement for providing ranging information within the ranging application service area. The method may further comprise receiving a request from a client UE. The method may further comprise discovering location information for a plurality of UEs within the ranging application service, wherein obtaining the location information may comprise receiving location information via an assistant UE. The method may further comprise processing or calculating ranging information based on the obtained location information. The method may further comprise sending the processed ranging information to the location management server entity and/or a consumer of the ranging service.

The method may include a reference/assistant UE requesting and receiving a ProSe application code for announcing its capability.

The method may include obtaining location analytics instead of location reports for configuring and calculating ranging information.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communication standards, these examples are not intended to be the limit of the communication standards to which the disclosed method and apparatus may be applied. For example, while specific examples have been given in the context of 3GPP, the principles disclosed herein can also be applied to another wireless communication system, and indeed any communication system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

The following abbreviations are relevant in the field addressed by this document: LCS, Location Services; LoS, Line of Sight; SL, Sidelink; ProSe, Proximity-based Services; nLoS, non LoS; LM, Location Management; LMS, LM Server; CAPIF, Common API Framework; VAL, Vertical Application Layer; VAE, V2X Application Enabler; LMC, Location Management Client; AC, Application Client; SNA, Subscriber-aware Northbound Access; and SEAL, Service Enabler Application Layer.

1. A network node for wireless communication, comprising:
at least one memory; and
at least one processor coupled with the at least one memory and configured to cause the network node to:
obtain information associated with locations of a plurality of user equipments (UEs);
evaluate in respect of a pair of UEs from the plurality of UEs based at least in part on the obtained information associated with locations of the pair of UEs, whether there exists a requirement for utilizing a further UE to assist in a ranging application service; and
if the further UE is required to be utilized,
select the further UE based at least in part on information associated with a location of the further UE, and
send at least one side-link positioning configuration information to the pair of UEs and the further UE.

2. The network node of claim 1, wherein the at least one processor is further configured to cause the network node to receive a request to provision side-link positioning configuration information for the ranging application service.

3. The network node of claim 1, wherein the side-link positioning configuration information comprises at least one of:
an identity and an address for each of the pair of UEs;
an identity of the further UE;
UE ranging capabilities;
side-link configuration policies and/or parameters;
a list of client UEs and addresses;
a capability exposure level;
an allowable transmission mode;
a configuration for out of coverage scenarios; or
a list of UEs participating in the ranging application service.

4. The network node of claim 1, wherein the at least one processor is further configured to cause the network node to select the further UE based at least in part on location information and a capability of the further UE.

5. The network node of claim 2, wherein the at least one processor is further configured to cause the network node to send a request that confirms selection of the further UE.

6. The network node of claim 1, wherein the at least one side-link positioning configuration information comprises information to enable an interaction with a proximity function.

7. The network node of claim 1, wherein the at least one processor is further configured to cause the network node to configure a list of UEs participating in the ranging application service.

8. A method performed by a network node, the method comprising:
obtaining information associated with locations of a plurality of user equipments (UEs);
evaluating in respect of a pair of UEs from the plurality of UEs based at least in part on the obtained information associated with locations of the pair of UEs, whether there exists a requirement for utilizing a further (UE) to assist in a ranging application service; and
if the further UE is required to be utilized,
selecting the further UE based at least in part on information associated with a location of the further UE, and
sending at least one side-link positioning configuration information to the pair of UEs and the further UE.

9. The method of claim 8, further comprising receiving a request to provision side-link positioning configuration information for the ranging application service.

10. The method of claim 8, wherein the side-link positioning configuration information comprises at least one of:
an identity and an address for each pair of UEs;
an identity of the further UE;
UE ranging capabilities;
side-link configuration policies and/or parameters;
a list of client UEs and addresses;
a capability exposure level;
an allowable transmission mode;
a configuration for out of coverage scenarios; or
a list of UEs participating in the ranging application service.

11. A user equipment (UE) operating as a reference UE or a further UE in a ranging application service area, the UE comprising:
at least one memory; and
at least one processor coupled with the at least one memory and configured to cause the UE to:
receive at least one side-link positioning configuration information from a location management entity.

12. The UE of claim 11, wherein the side-link positioning configuration information comprises information to enable an interaction with a proximity function.

13. The UE of claim 12, wherein the at least one processor is further configured to cause the UE to:
obtain proximity information from the proximity function for announcing a role in a ranging application service; and
announce the role in the ranging application service.

14. The UE of claim 11, wherein the UE is a reference UE, and wherein the at least one processor is further configured to cause the reference UE to:
receive a request for providing ranging information within the ranging application service area;
determine information associated with locations of a plurality of user equipments (UEs) within the ranging application service area; and
determine ranging information based at least in part on the determined information associated with the locations of the plurality of UEs.

15. The UE of claim 14, wherein the request is comprises a request to detect a requirement for providing ranging information within the ranging application service area received from a client UE, an allocation management entity or an application server.

16. The UE of claim 14, wherein the at least one processor is further configured to cause the UE to send the ranging information to a consumer of the ranging service.

17. The UE of claim 14, wherein the at least one processor is further configured to cause the UE to send the ranging information to the location management entity.

18. The UE of claim 14, wherein to determine the information associated with locations of the plurality of UEs within the ranging application service, the at least one processor is further configured to cause the UE to:
send a location information request to a target UE, wherein the request includes an identity of a vertical application layer (VAL) service for which the location information is requested; and
receive a location information report.

19. (canceled)

20. The UE of claim 14, wherein to determine the information associated with locations of the plurality of UEs within the ranging application service, the at least one processor is further configured to cause the UE to:
send a request to the location management entity to obtain location information for target UEs.

21. A method performed by a UE in a ranging application service area, the method comprising:
receiving at least one side-link positioning configuration information from a location management entity.
